(19) United States
(12) Patent Application Publication
(10) Pub. No.: US 2024/0272963 A1
(43) Pub. Date: Aug. 15, 2024

(54) SOFTWARE KIT FOR INTER-APPLICATION COMMUNICATIONS

(71) Applicant: IQVIA Inc., Parsippany, NJ (US)

(72) Inventor: Olivier Cadou, Parsippany, NJ (US)

(21) Appl. No.: 18/437,051

(22) Filed: Feb. 8, 2024

Related U.S. Application Data
(60) Provisional application No. 63/444,712, filed on Feb. 10, 2023.

(51) Int. Cl. G06F 9/54; H04W 4/60; H04W 68/00

(52) U.S. Cl. CPC G06F 9/541; H04W 4/60; H04W 68/005

(57) ABSTRACT

Methods, systems, and apparatus, including computer programs encoded on computer storage media, for cross platform communications. In some implementations, a first request is received over a network for an application from a client device. In response, application data is generated that includes a software development kit (SDK) incorporated in the application. Tracking data is generated that comprises (i) data identifying the SDK and (ii) data identifying the client device. The generated application data is provided to the client device, the SDK incorporated in the application enabling the application of the client device to communicate with a different application, wherein the SDK is incorporated in the application responsive to receipt of the first request. A list of applications are identified that have the SDK based on the tracking data. A message is generated and provided to each application on the list.

### CROSS-REFERENCE TO RELATED APPLICATION

This application claims the benefit of U.S. Provisional Application No. 63/444,712 filed on Feb. 10, 2023, which is incorporated herein by reference.

### TECHNICAL FIELD

This specification relates to device communications, and one particular implementation relates to a software development kit that enables communications between different applications.

### BACKGROUND

An application program or computer program can be configured to perform a specific task based on a request from a user or through passive processing. The application program can perform manipulation related to, for example, text, numbers, audio, video, and other data elements for accomplishing a task. In order to perform processes related to manipulating these different data elements, the application program can rely on different functions included within the application program to produce an intended result related to accomplishing the task.

### SUMMARY

The techniques described in this specification provide for cross platform communication capabilities among applications, websites, or both (hereinafter “applications”) that are typically unable to communicate with one another. A system, such as one that includes one or more servers, can incorporate a software development kit (SDK) into an application and can deploy the application to various devices. The application on the devices can use the functions of the SDK to perform inter-application communication. In some implementations, the application with the incorporated SDK can communicate with a different application that it may not have been able to communicate with otherwise. Thus, the SDK incorporated in the application enhances the flexibility of the application by providing a capability to exchange data with different applications by way of an SDK server, which may include one or more SDK servers.

In some implementations, the techniques described in this specification can enable one-way communication to applications that include the SDK. Specifically, the applications that include the incorporated SDK can receive a centralized message from a campaign manager and an SDK server. For example, the campaign manager can determine or identify which applications have incorporated the SDK by retrieving a list of applications that have incorporated the SDK from the SDK server. In response, the campaign manager can generate a message to distribute to each of the applications that include the incorporated SDK. In some implementations, the campaign manager can select one or more applications to transmit the generated message based on various criteria. In response, the campaign manager can transmit the message to the SDK server, and the SDK server can transmit or broadcast the generated message to each of the selected applications that include the incorporated SDK. In response to each SDK receiving the generated message, the generated message can be delivered instantaneously as a message or a notification or delivered to the user at a later point in time, such as when the user is online or interacting with the application. In some cases, the centralized distribution is beneficial for notifying users through their preferred applications, as will be further described below.

In some implementations, the campaign manager can identify which applications have the incorporated SDK by communicating with the SDK server and select which of the identified applications to include for the centralized distribution. For example, the campaign manager can identify from multiple applications, a select number of applications that have the incorporated SDK to provide a generated message. This filtering of applications can be beneficial when the campaign manager seeks to communicate directly with or receive responses directly from, for example, specific family members, a specific group, employees of a corporation, or other specified groups of individuals, each including the application.

Typically, an application has a respective backend application server and similarly, a website has a respective website backend server. The respective backend application server can perform functions and processes related specifically to the application. Similarly, the respective website backend server can perform functions and processes related specifically to the website.

The application and the website may not include the functionality to communicate with one another due to (i) different communication protocols and mechanisms, (ii) different application programmable interface (API) functional calls, or (iii) different data exchanges, to name a few examples. Additionally, the respective backend application server and the respective website backend server may not be able to communicate with one another due to similar functionality issues. By integrating the SDK in both the application and the website, the application and the website can communicate with one another because they both now share the same SDK server as a communication medium.

In some implementations, in one-way communication, the campaign manager can target applications that include the incorporated SDK and instruct the SDK server to transmit or broadcast messages to the targeted applications. In some implementations, in two-way communication, the SDK server maintains access of a directory. As will be further described below, the directory stores data indicative of user profiles. The user profiles store address information of other applications owned or utilized by users that store the SDK. The SDK server can store communication data that tracks the identifiers (IDs) of senders and receivers during two-way communications. For example, when a sender of one application sends a message to a user of another application through the SDK server, the sender sends an identifier along with the message. The SDK server can receive the message, identify the recipient from the directory, store the identifier of the sender, and transmit the message to the recipient. Thus, should the recipient decide to reply to the sender and the recipient sends a reply message, the SDK server can access the sender's identifier from the directory in determining which user to transmit the reply message. The sender's identifier can be used as contact information without storing the sender's personal details, which reduces the amount of data that needs to be stored for two-way communication.

In some implementations, a user of one application of a device that includes the incorporated SDK can request to communicate with a different user of a different application that includes the incorporated SDK. For example, a user of a social media application may request to communicate with a different user of a financial application. To enable the two users to communicate, the social media application and the financial application can include or have the ability to use functions from their respective incorporated SDK, as both applications will share a communication medium, e.g., the SDK server. The SDK server can include one or more components that manage communications with the incorporated SDK installed with each application. For example, the SDK server can store a directory that includes user profiles of users who own applications that incorporate an SDK. Continuing with the above example, when the SDK server receives the message from the social media application, the SDK server can use identifiers in the message to access contact information, e.g., one or more identifiers, of the financial application to determine where and how to route the message to the financial application. At that point, the SDK server can transfer the message to the financial application, which is ultimately presented to the user of the financial application.

In one general aspect, a method performed by one or more computers includes: receiving, by one or more processors and from a plurality of client devices, a first request over a network for an application; in response to receiving each first request, generating, by the one or more processors, application data that includes one or more software development kits (SDKs) incorporated in the application; generating, by the one or more processors, tracking data that comprises (i) data identifying the one or more SDKs incorporated in the application and (ii) data identifying the client device that transmitted the first request for corresponding application data; providing, by the one or more processors, the generated application data over the network to each client device that transmitted the first request, the one or more SDKs incorporated in the application enabling the application of each client device to communicate with a different application of a different or similar client device, wherein the one or more SDKs are incorporated in the application responsive to receipt of the first request; identifying, by the one or more processors, a list of applications on the plurality of client devices that have the one or more

SDKs based on the generated tracking data; generating, by the one or more processors, a message to provide to each application on the list of applications; and providing, by the one or more processors, the generated message to each application that includes the one or more SDKs, wherein the message includes a notification to be displayed on each client device through each application.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, wherein generating the application data that includes the one or more SDKs further includes generating, by the one or more processors, identifying, by the one or more processors, the one or more SDKs based on an operating system of the client device which transmitted the first request.

In some implementations, the method further includes: receiving, by the one or more processors, a second request from a first application of a first client device to communicate with a second application of a second client device, wherein the first application includes the one or more SDKs; determining, by the one or more processors, whether the second application of the second client device includes the one or more SDKs; and in response to determining that the second application of the second client device includes at least the one or more SDKs, providing, by the one or more processors, an indication to the first application that enables the first application to communicate with the second application.

In some implementations, the method further includes: receiving, by the one or more processors, a second request from a first application of a first client device to communicate with a second application of a second client device, wherein the first application includes the one or more SDKs; determining, by the one or more processors, whether the second application of the second client device includes the one or more SDKs; and in response to determining that the second application of the second client device does not include the one or more SDKs, providing, by the one or more processors, an indication to the first application that precludes the first application from communicating with the second application.

In some implementations, the method further includes: receiving, by the one or more processors, a third request from a first application of a first client device to communicate with a second application of the first client device, wherein the first application includes the one or more SDKs; determining, by the one or more processors, whether the second application of the first client device includes the one or more SDKs; and in response to determining that the second application of the first client device includes at least the one or more SDKs, providing, by the one or more processors, an indication to the first application that enables the first application on the first client device communicate with the second application on the second client device.

In some implementations, the tracking data includes a user identifier, a client device identifier, an application identifier, and the one or more SDKs for the application of the respective client device.

In some implementations, providing the generated message to each application that includes the one or more SDKs further includes providing, by the one or more processors, the message to each of the one or more SDKs of each application on each client device, wherein the message comprises at least one of a text message, a hyperlink, and an image.

In some implementations, providing the generated message to each application that includes the one or more SDKs further includes providing, by the one or more processors, the message to each of the one or more SDKs of each application on each client device when the client device is powered off, and enabling a user of the client device to receive a notification of the message when the respective client device is powered on.

In some implementations, generating a message to provide to each application on the list of applications further includes generating, by the one or more processors, the message to provide to each application on the list of applications such that each application shares a similar backend server to enable communications between different applications of similar and different client devices.

In some implementations, generating the message to provide to each application on the list of applications further includes generating the message to provide to each application on the list of applications to be displayed at a future date and future time.

In some implementations, the method further includes: providing, by the one or more processors, a user interface that displays (i) the list of applications that incorporates the one or more SDKs on each client device, (ii) a number of requests transmitted and received from each of the one or more SDKs on each application of each client device, and (iii) a type of the one or more SDKs.

In some implementations, the method further includes: in response to receiving the first request over the network for the application, determining, by the one or more processors, a validation of the client device for receiving the application with the incorporated one or more SDKs, wherein the validation comprises at least one of: determining, by the one or more processors, whether the client device has sufficient memory for utilizing the application with the incorporated one or more SDKs; determining, by the one or more processors, whether the client device has an operating system that matches to an operating system designated for the incorporated one or more SDKs; and determining, by the one or more processors, whether technical components of the client device can (i) utilize the one or more SDKs and (ii) receive and transmit messages from different applications of other client devices and the same client device.

The subject matter described in this specification can be implemented in various embodiments and may result in one or more of the following advantages. In particular, the system can improve the diversification of communication between dissimilar websites and applications. Similarly, the system can notify recipients more quickly through their preferred applications. The system can communicate directly with this user's preferred application that includes the incorporated SDK and ensure quick responses from the user. On the contrary, if communications are directed to an application or a website not typically used by the recipient, the responses may be delayed or the system may not ever receive responses due to the user's lack of usage with that particular application.

The system can also directly benefit from not only sharing messages between different applications and websites, but also sharing features specific to those applications and websites. For example, a social media application may include functionality related to recommending music for a particular user and a financial application may not include such functionality. By incorporating the deployed SDK into the social media application and into the financial application, the social media application may transmit music recommendations to the financial application for the corresponding user. This may be useful when, for example, the user is perusing through different stocks, exchange-traded funds (ETFs), and mutual funds, by recommending music users typically listen to when performing financial transactions. Other examples of sharing features between different applications and/or different websites are also possible, as will be outlined and described below.

An SDK incorporated into applications and websites can enable the applications and the websites to benefit through its prebuilt screens and various components. For example, an SDK can enable the application and website to rely on a communication channel, which can be used for chatting, performing video calls, exchanging data, and exchanging files In this case, the SDK can benefit from a communication channel, which can be used to chat, to create video conferences, exchange files and data, and other components, with other different and/or similar applications. In some examples, the SDK can include an integrated game, e.g., chess, checkers, and others, in which the user of an application can play with other users of different applications that also store the SDK with the integrated game. In some examples, the SDK can include a search engine in which a user of the application can search for any desired topic, e.g., healthcare professionals, experts, automobile dealers, and others. The SDK offers flexibility to the application in which more utilization can be realized.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram that illustrates an example of a system for broadcasting a message to applications that include a software development kit (SDK).

FIG. 1B is a block diagram that illustrates an example of a system for communications between applications that each include the SDK.

FIG. 2A is a flow diagram that illustrates an example of a process for distributing a message to applications that include the SDK.

FIG. 2B is a flow diagram that illustrates an example of user interfaces for distributing a message to applications that include the SDK.

FIGS. 3A-3B are flow diagrams that illustrate examples of a process for providing notifications to applications that each includes the SDK.

FIG. 4 is a flow diagram that illustrates an example of a process for end-to-end communications between applications that include the SDK.

FIGS. 5A-5E are flow diagrams that illustrate examples of a process for an application to bi-directionally communicate with a specified application that includes the SDK.

FIG. 6 is a flow diagram that illustrates an example of a process for enabling end-to-end communications between different applications on various client devices.

FIG. 7 shows a block diagram of a computing system that can be used in connection with methods described in this document.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

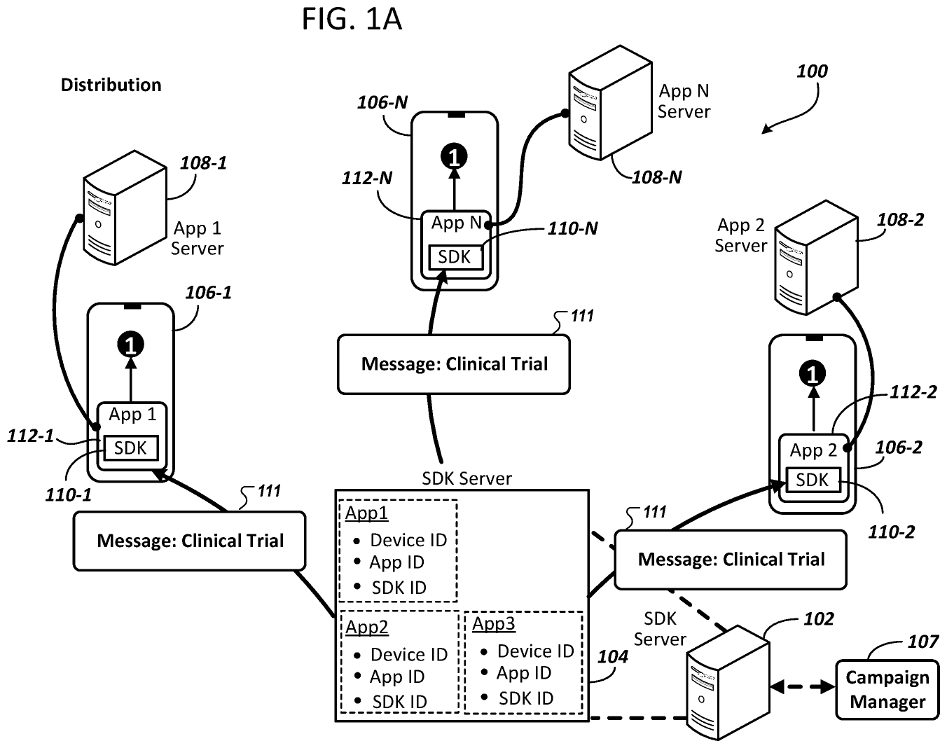

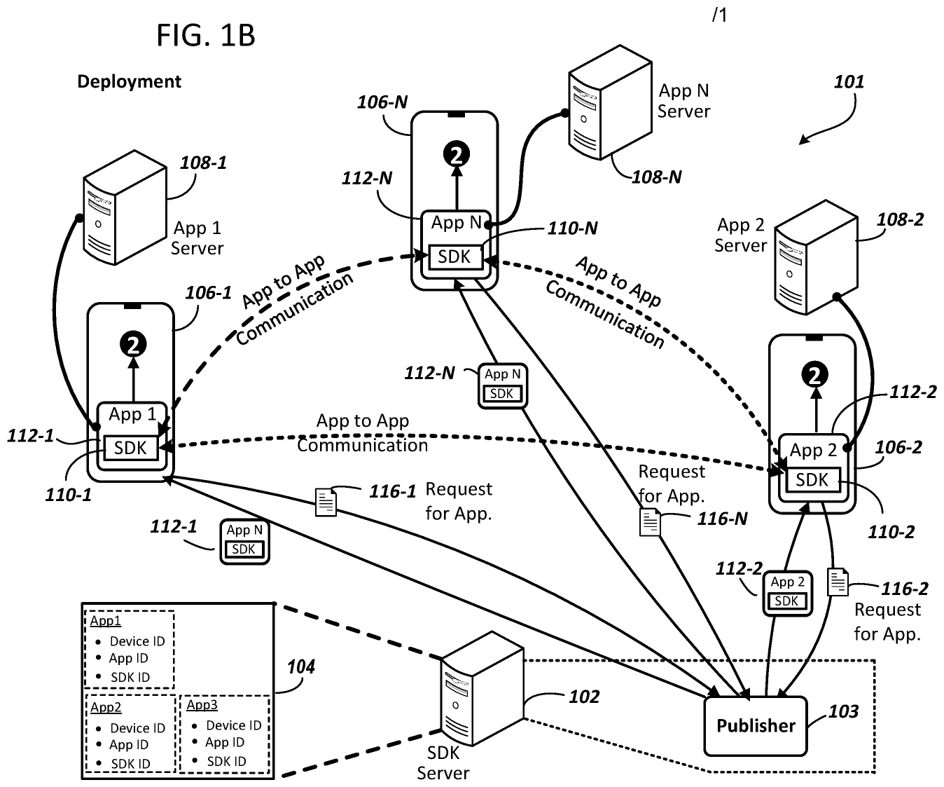

FIG. 1A is a block diagram that illustrates an example of a system 100 for broadcasting a message to applications that include a software development kit (SDK). Specifically, the system 100 can be an environment in which an SDK is deployed in one or more applications, websites, or both (hereinafter “applications”). The SDK incorporated in these applications can receive one or more messages broadcasted by a server 102. FIG. 1A illustrates various operations that can be performed in the sequence indicated as describe below, in another sequence, with additional processes, or fewer processes.

In some implementations, the system 100 includes an SDK server 102, client devices 106-1 through 106-N (collectively “client devices 106”), a campaign manager 107, and backend application servers 108-1 through 108-N (collectively “backend application servers 108”). The SDK server 102 can include one or more computers connected locally or connected over a network. The one or more computers of the SDK server 102 can include one or more databases that stores data 104 pertaining to application tracking. This will further be described below. The SDK server 102 can communicate with the client devices 106 over a network. The network can include for example, a local network, such as Bluetooth, Wi-Fi, or a larger network, such as the Internet, to name a few examples. Alternatively, a user may directly interact with the SDK server 102 by way of a touchscreen, a monitor, keyboard, and mouse, or some other form of interaction.

The client devices 106 can include, for example, a mobile device, a personal computer, a handheld device, a portable device, a tablet, an embedded microprocessor device, and other devices. The client devices 106 can also include a server, multiple servers, and other devices that act as standalone devices and can communicate with the SDK server 102 over a network. In an example, the system 100 can enable similar and different types of client devices 106 to communicate with one another.

The SDK server 102 can communicate with the client devices 106 over the network for various purposes. Specifically, the SDK server 102 can communicate with the client devices 106 by receiving requests from the client devices 106, broadcasting messages to applications of the client devices 106 that include an SDK, providing messages to a subset of the client devices 106, and for other purposes, such as for authorization and login purposes.

The SDK server 102 can communicate with a campaign manager 107. In some examples, the campaign manager 107 can include one or more computers connected locally or connected over a network. In some examples, the campaign manager 107 can be include as an application, a website, or other component within the SDK server 102. As will be further described below, the campaign manager 107 can identify which applications of client devices 106 have an incorporated SDK and select which of the identified applications to include for the centralized distribution. Moreover, the campaign manager allows a user or other to define and execute broadcast campaigns. The campaign manager can first request from the SDK server 102 information about applications and websites that each integrates the SDK. In response, the campaign manager can determine which of these applications and websites to use for centralized distribution.

The SDK server 102 may also communicate with various databases. The various databases can store information for identification and tracking of client devices 106 as well as for tracking each application that includes the SDK in each of the client devices 106. Additionally, the SDK server 102 may communicate with an SDK backend server, which can perform the storing of various SDK frontend module identifications and distribution of broadcasting messages.

Typically, each of the client devices 106 can include one or more applications. These applications can include, for example, social media applications, financial applications, health applications, exercise applications, photograph applications, and messaging applications, to name some examples. The client devices 106 may also include browsers or internet exploring applications that provide interfaces to various websites that associated users can interact with through the browsers. Each of these applications can include a respective backend server.

A backend application server for a respective application can, for example, provide regularly scheduled updates, receive identifications of issues associated with the application, perform scheduled maintenance on the application, manage performance of the application during operating hours, or other maintenance actions. Additionally, the backend application server for a respective application can manage operations associated with communications between the same applications across multiple client devices.

In some implementations, the client devices 106 can request to install an additional application. The client devices 106 can communicate with an application store, such as a publisher or a directory. The application store can include a variety of applications that can be downloaded by users of the client devices 106. For example, the client device 106-1 can request from the publisher to download application 112-1, client device 106-2 can request from the publisher to download application 112-2, and client device 106-N can request from the publisher to download application 112-N. The publisher can incorporate an SDK frontend module in each of the applications. Then, the publisher can provide the applications that include the incorporated SDK to each of the client devices 106 in response to receiving the requests from each of the client devices 106.

In some implementations, the SDK server 102 can provide an SDK frontend module to the publisher. The publisher can incorporate the SDK frontend module in each of the applications. When each of the client devices 106 request for one or more applications from the publisher, the publisher can provide the requested applications that include the incorporated SDK to the client devices 106.

The SDK frontend module can include one or more SDKs that enable applications to receive messages from the SDK server 102 (and/or the SDK backend). The client devices 106 can install the applications after receiving the applications from the publisher and utilize the functions provided by the SDK frontend module in the installed applications.

Additionally, the SDK server 102 may include a backend service or SDK backend. The backend service can communicate with the one or more deployed SDKs in the SDK frontend module of each application that has been installed on the client devices 106. As will be further described below, the SDK server 102 can include or communicate with an SDK backend that allows for broadcasting communications to the one or more applications that have the incorporated SDKs on the client devices 106.

Once the applications are installed on the client devices 106, each application can be managed by a respective backend server. For example, application 112-1 may communicate and be managed by a respective backend application server 108-1. Client device 106-N can include an example application 112-N, which may communicate and be managed by a respective backend application server 108-N. Similarly, client device 106-2 may include an example application 112-2, which may communicate and be managed by a respective backend application server 108-2. Each of the client devices 106 can include other applications, e.g., client device 106-1 can include 100 applications, client device 106-2 can include 90 applications, and client device 106-N can include 100 applications; however, only one application is described with respect to system 100 for example purposes.

In some implementations, similar applications may communicate with one another across different client devices. For example, application 112-1 and application 112-N may both by the same social media application. In this case, the user's associated with client devices 106-1 and 106-N may communicate with one another through application 112-1 and application 112-N, respectively. Application 112-1 may communicate with application server 108-1 and application 112-N may communicate with application server 108-N. In this example, since both applications 112-1 and 112-N are the same applications, application server 108-N and application 108-1 can be the same application server. However, application 112-2 may be a financial application and cannot communicate with applications 112-1 and 112-N because these applications are different. In order to remedy this communication issue, the SDK 110-1 in application 112-1, the SDK 110-N in application 112-N, and the SDK 110-2 in application 112-2 can enable these different applications to communicate. This will be further elaborated below.

In some implementations, the publisher can perform a validation when a client device requests for an application that includes an SDK. For example, the client device 106-1 may request to download and install application 112-1 that includes an incorporated SDK, which may include a social media application. In response, the publisher can request for characteristics of the client device from the client device to determine whether the client device can operate the SDK.

In some implementations, the publisher can automatically provide the application with the incorporated SDK to a client device for downloading and installation. For example, when a user downloads a particular application to their client device, e.g., downloads and installs a medical application, the particular application includes the SDK frontend module. When the user installs the downloaded application on their client device, the client device can recompile the application and the SDK frontend module to prepare for execution.

In response to the publisher receiving a request from the client device, e.g., client device 106-1, the publisher can perform a validation process. The validation process can ensure (i) the client device has the correct functionality to install and utilize the incorporated SDK in the client device application and (ii) to determine a type of SDK to build for the client device. For example, the publisher may transmit a validating request to the client device in response to receiving the application request from the client device. The validating request can include a request for the hardware and software components of the requesting client device. The client device can respond with validation information, e.g., a detailed list of hardware and software components, of the requesting client device. The validation information can include, for example, an operating system of the client device, an IP address, a MAC address, storage capabilities, e.g., available and used memory, a number of applications on the client device, a make and model of the client device, a carrier provider of the client device, or other types of validation information, should the client device correspond to a cellular device.

In some implementations, the publisher can receive the validation information from the client device to determine whether the client device (i) has the correct functionality to utilize the SDK frontend module and (ii) to determine a type of SDK frontend module to build. The publisher can analyze the validation information to determine, e.g., whether sufficient space is available on the client device, the type of operating system used by the client device, whether the client device is executing on the latest operating system for the respective operating system, and what applications the client device expects to use with the SDK frontend module, to name a few examples. The publisher can also determine whether the client device has sufficient storage available to receive the application with the incorporated SDK frontend module, whether the hardware components on the device can handle the application with the incorporated SDK frontend module, or whether the software components used by the client device can handle the SDK frontend module. Other examples are also possible.

If the publisher determines that the requesting client device does not meet at least one of these criteria for handling an SDK, then the publisher can transmit a message indicating that the requesting client device cannot properly handle the application. For example, the publisher may determine that the requesting client device does not meet the hardware requirements for the requested application. Alternatively, if the publisher determines that the requesting client device can handle the SDK but that one or more upgrades are appropriate, then the publisher can recommend that the client device perform the upgrades before the client device application is transmitted. The upgrades can include, for example, operating system upgrades, firmware upgrades, make more storage available, or other software type upgrades.

In some implementations, the SDK server 102 can generate one or more SDKs for client devices that operate on an outdated or previous version of an operating system. For example, the SDK server 102 can generate an SDK frontend module for an operating system that operates on the latest version of iOS™ or operates on one or more previous versions of Android™. In another example, the SDK server 102 can generate an SDK frontend module for other current and previous versions of operating systems. The publisher can request for the particular operating system of a client device due to functionality required by the SDK frontend module. In response, the publisher can provide the hardware, software, and operating system characteristics to the SDK server 102. There may be incompatibility issues if the SDK server 102 generates an SDK frontend module based on a newer version of an operating system for a client device that runs on an older version of the same operating system. Then, the SDK server 102 can provide the SDK frontend module with a version of the operating system based on the request to the publisher. The publisher can integrate the latest SDK frontend module received from the SDK server 102 into the application and can provide the application with the integrated SDK to the client device.

In some implementations, the SDK server 102 can determine that a particular client device can receive an SDK frontend module in response to successfully validating the software and hardware components of the particular client device. Specifically, the SDK server 102 can determine that a particular client device is successfully validated to join a network supported by the SDK server 102 in response to the software and hardware of the particular client device meeting various criteria. For example, the SDK server 102 can determine that client device 106-1 is successfully validated to join a network supported by the SDK server 102 in response to determining (i) the client device 106-1 runs the latest version of iOS™, (ii) includes a particular amount of free memory, (ii) and the device is password protected. Other examples are also possible. The SDK server 102 can then proceed to generate an SDK frontend module for the particular device. The SDK server 102 can transmit the generated SDK frontend module to the publisher, and the publisher can integrate the generated SDK frontend module into an application to be requested for by the client devices 106.

The SDK server 102 can generate the SDK frontend module for the particular application by acquiring software that will run on the particular device. The SDK frontend module can include various libraries of functions, API calls, one or more SDKs, and other software that will enable various applications on the client device to communicate with different applications on the same client device and across different client devices. Additionally, the SDK server 102 can generate various characteristics representative of the SDK. The various characteristics can include, for example, a device ID, an application ID, and an SDK ID, to name a few examples.

As illustrated in system 100, the SDK server 102 can store data 104 that includes characteristics representative of various SDKs that have been previously generated. For example, the data 104 includes data for application 1 that includes a device ID of 001, an application ID of 01234, and an SDK ID of 1265. The data 104 includes data for application 2 that includes a device ID of 001, an application ID of 012346, and an SDK ID of 1266. The data 104 includes data for application 3 that includes a device ID of 002, an application ID of 23541, and an SDK ID of 1201. Thus, the data 104 can include characteristics representative of various SDKs for the same client device, e.g., indicative of the device ID, with different applications as well as different client devices and the same or different applications. By generating this tracking information, the SDK server 102 can identify and monitor which client devices, and more specifically, which applications of the various client devices have incorporated the SDK frontend module.

In response to generating the SDK frontend module for a particular application of a particular client device, the SDK server 102 can transmit the generated SDK frontend module to the publisher. The publisher can integrate the generated SDK frontend module into an application. In response, the publisher can provide the application with the integrated SDK frontend module to the client device. The particular client device can receive the application with the incorporated SDK frontend module and install, compile, and execute the respective application with the incorporated SDK frontend module.

For example, the client device 106-1 can receive the application 112-1 with the integrated SDK 110-1 from the publisher, and install, compile, and execute the SDK 110-1 when executing the application 112-1. Similarly, the client device 106-N can receive the application 110-N with the integrated SDK 110-N from the publisher, and install, compile, and execute the SDK 110-N when executing the application 112-N. The client device 106-2 can receive the application 110-2 with the integrated SDK 110-2 from the publisher, and install, compile, and execute the SDK 110-2 when executing the application 112-2. Then, the SDK server 102 can track which client devices, e.g., client devices 106-1, 106-2, and 106-N, have applications with incorporated SDK frontend modules and use that data for identifying applications when performing message broadcasting.

In some implementations, the SDK server 102 may broadcast data to the applications that include the SDK. Specifically, the SDK server 102 can include or communicate with a campaign manager 107 that can identify the applications that include the SDK frontend module for distributing or broadcasting data. The SDK server 102 can identify each of the applications that include the SDK frontend module or a subset of applications that include the SDK frontend module, and provide that information to the campaign manager 107. The campaign manager 107 can select one or more applications and websites to be utilized in the distribution or broadcasting. In response, the campaign manager 107 can notify the SDK server 102 which of the applications or websites to should receive the distributed or broadcasted data. The data can include video, notifications, messages, polls, audio, presentations, and other information to provide to users. The SDK server 102 can then distribute or broadcast the data, which can be provided through push notifications, email, text messages, alerts, and other mannerisms.

The SDK server 102 can broadcast or deliver the data to the applications specified by the campaign manager 107 that include the SDK frontend module at a first time, which subsequently delivers the data as a notification at a second time. This may be beneficial if the client device or the application is currently turned off or not running actively or in the background, respectively. In this case, the SDK server 102 can deliver the notification to the application with the SDK frontend module at a first time, e.g., 12:00 PM, and the notification can be delivered at a second time, e.g., 3:00 PM, regardless of whether the application is currently executing in the background, the foreground, or not executing at all.

For example, as illustrated in in system 100, the SDK server 102 can determine that applications 112-1, 112-2, and 112-N include an incorporated SDK frontend module. As such, applications 112-3 through 112-(N−1) do not include an incorporated SDK frontend module, assuming N is a value greater than 3. In this manner, the SDK server 102 can broadcast any message to the applications 112-1, 112-2, and 112-N. For example, the SDK server 102 can broadcast a clinical trial participant message 111 to each of the SDK frontend modules of each client device. The clinical trial participant message 111 can instruct the SDKs 110-1, 110-2, and 110-N to notify the user of the respective client device of the data in the message 111 at a later point in time, e.g., 1 day later, 2 days later, 1 week later, or another set time.

In some implementations, each application on a client device can include a corresponding authentication token. When a user first logs into an application on a client device, the user provides credentials, e.g., username, email, and password to authenticate and set up a profile with the application. In response, the application transmits a request to the corresponding application server for an authentication token, the request including the user credentials. In response to receiving the request, the application server can validate the request, create an authentication token, store a corresponding user ID and device ID for the created authentication token, and transmit the created authentication token to the application on the client device for use.

An authentication token can include a particular duration for use that indicates to the application server a period of time during which the user's authenticity for the application is valid. Outside of the period of time of the authentication server, e.g., if the period of time elapses, the application server kills the authentication token and deletes the user ID and device ID. Each authentication token has a particular duration, e.g., 1 hours, 2 hours, 10 days, two months, one year, longer, or shorter, to name some examples. The user can close and reopen an application without having to log in to the application while the authentication token remains valid.

In this manner, the authentication token that is still viable (or has not yet lapsed in duration) does not disconnect users from the corresponding application. Each time a user reopens an application before the authentication token elapses, the authentication token extends its duration. For example, a user may open an application that has been closed every one hour, which can extend the token's duration for a large period of time. In these cases, the users are not fully disconnected from the application because the authentication token is still valid, which means that the application can receive push notifications, messages, and/or emails from the SDK server 102 or other client devices. Thus, these applications can receive push notifications, messages, and/or emails even if the application is closed (and not logged out) on the client device. As long as the authentication token for the closed application has not elapsed, the application can still receive push notifications, messages, and/or emails even when the application is closed. Moreover, the application can communicate with other applications on the client device and with other applications on the network over the SDK server 102 while the authentication token remains valid.

For example, if the SDK server 102 sends a message to application 112-1 that includes SDK 110-1 of client device 106-1, the application 112-1 can receive the message as long as the corresponding authentication token (created and provided by application server 108-1) is still valid. In this example, the application 112-1 may be closed, and as long as the corresponding authentication token has not lapsed or the user has not logged out of application 112-1, then the application 112-1 can receive a message from the SDK server 102. The SDK server 102 can send the message to application 112-1, which may be received as a silent push, which is invisible to the user. The client device 106-1 can receive the silent push, wake up the corresponding application 112-1, determine the application 112-1 is still valid based on its authentication token, provide the message to the application 112-1, and the application 112-1 can return to a sleep state until a date and time designated by the message for notification delivery. At the date and time designated by the message, the application 112-1 can wake up and deliver a notification for the user. If an authentication token is killed after an application 112-1 has received the message or notification, the application 112-1 can deliver a notification to the user at the designated date and time without the use of the authentication token. However, the application 112-1 can request a new authentication token from the application server 108-1 once the user logs in to the application 112-1 to view the message or notification.

An authentication token is typically terminated when a user logs out of the application or the duration of the authentication token elapses without application use. At this point, the user will have to log back into the application, which requires user authentication and for the application to request new authentication token from the corresponding application server. When an authentication token elapses, the application server severs the connection with the corresponding application and removes the corresponding user ID and device ID. This means the application server (or the SDK server 102) is no longer able to send messages, emails, or push notifications to the corresponding application, because there is no ability to communicate with an SDK of the application.

FIG. 1B is a block diagram that illustrates an example of a system 101 for communications between applications that each include the SDK. The system 101 illustrates similar components as system 100, and will not be described here. Specifically, the system 101 illustrates applications that have incorporated the SDK frontend module and how those applications can communicate with one another using their respective SDK frontend module.

In some implementations, the client devices 106 can request for applications from a store or publisher, such as publisher 103. The publisher 103 can include a store that can be separate from the SDK server 102. For example, the client device 106-1 can transmit a request 116-1 to the publisher 103 for a particular application. The client device 106-N can transmit a request 116-N to the publisher 103 for a particular application. The client device 106-N can transmit a request 106-2 to the publisher 103 for a particular application.

In response to receiving the request, the publisher 103 can provide the requested application to each client device. However, before providing the requested application to each client device, the publisher 103 can receive one or more compiled application with one or more SDK frontend modules 114 from developers. A developer can incorporate the one or more SDK frontend modules 114 into one or more desired applications, recompile the desired applications, and publish the recompiled applications on the publisher 103.

When the client devices receive and install the applications with the incorporated SDK frontend modules 114, each respective client device can use the functionality of the SDK frontend modules 114 and the corresponding applications. For example, in system 101, client device 106-1 and client device 106-2 both include the same social media application. The social media application enables friends to share texts, images, videos, and other media between one another. A user associated with client device 106-1 may desire to send a video of a recorded event to another user of client device 106-2 by way of the social media application. In this context, the client devices 106-1 and 106-2 may both include and have installed the social media application to enable the two to communicate the video of the recorded event from one device to the other. Additionally, the social media application may communicate with a respective backend application server for providing support for its operations. For example, the user of client device 106-1 can transmit a video from its social media application to the user of client device 106-2 by way of the backend application server, e.g., backend application server 108-1. The backend application server can receive the video from the social media application of client device 106-1, perform one or more functions on the received video, and redistribute the video to the social media application of client device 106-2 for the recipient's viewing.

However, an issue arises when the user of the social media application of client device 106-1 seeks to transmit a message or data to a different application, e.g., a financial application or a video sharing application, of client device 106-2 associated with a different user. In some implementations, a similar issue arises when the user of the social media application of client device 106-1 seeks to transmit a message or data to a different application of the same client device. In these examples, the social media application cannot communicate with the other application, e.g., the financial application, for example, because the two applications do not share the same backend functionality or the same backend application server. In order for the two different applications to communicate, a third party system can be utilized to act as an intermediary between the two different applications on the same client device or the two different applications on different client devices. However, the integration of a third party system involves an additional application or another service that is inserted between the two different applications to translate, convert, and redistribute the communications from one application to another. This can waste resources and can require the user or two users to have to download an additional application just to be able to communicate.

To avoid wasting resources, the techniques implemented by system 100 can enable two different applications, e.g., on different devices or on the same device, to communicate one another without involving a third party application or service as an intermediary. In system 100, the two different applications each can incorporate an SDK that shares a common backend server, e.g., SDK server 102, to enable direct communications between the two different applications. An SDK can be a collection of software development tools or functions provided or delivered in one installable package for a particular purpose. The SDK can facilitate the creation of applications by way of a compiler, debugger, installer, and/or some form of a software framework.

To ensure that the deployed SDK can work on client devices 106, the deployed SDK can be used for a particular framework, e.g., for a particular operating system, and rely on specific software development kits for that framework that enable, for example, advertisements, push notifications, periodic updates to the SDK server 102 for management of operations, and other processes. For example, different SDKs may be published for different frameworks—one SDK for iOS™, one SDK for Android™, and other framework specific SDKs. Moreover, the deployed SDK can take the form of an application-programming interface (API). The API of the SDK can include one or more libraries of reusable software functions that enable communications with one or more applications.

In some implementations, the deployed SDK can include one or more user interfaces and components that can provide a facilitated usage of multiple APIs. Specifically, the deployed SDK can provide access to one or more user interfaces for the application and a user can customize the user interfaces. For example, the one or more user interfaces can include interfaces for search engines, interfaces for playing a game of chess, interfaces for using a map to aid with navigation directions, and interfaces to search for various health care providers and identify their corresponding locations. The user can adjust various graphical elements on the user interfaces, move fields on the graphical elements, and remove one or more fields. In this manner, a new application or user interfaces of application can be created and customized from a single application that has incorporated the SDK.

Similarly, the SDK may provide or be deployed as a hardware specific toolkit that enables communication with an embedded system of the application. The API of the SDK can also provide debugging functions, utility building, and access to open source software, for the client device application. In one example, when the SDK is deployed in an application on a client device, the SDK can be used by the application, such as a social media application, a financial application, one or more websites, a photographing application, and other applications, to name some examples.

System 101 enables not only sharing different messages and/or notifications between different applications that include an incorporated SDK frontend module, but also sharing features specific to the applications. For example, a social media application may include functionality related to recommended music for a particular user and an exercise application may not include this functionality, though music recommendations may be beneficial during particular types of exercise. By incorporating the SDK into the social media application of one user's client device and into the exercise application of another user's client device, the social media application may transmit music recommendations to the exercise application of the other user. This can beneficial to help the other user during running, lifting, yoga, or performing interval training. The user can recommend music through their social media application to the other user to listen to while exercising. In this example, the other user can view the music recommendation and open a music application on their device while exercising. This reduces the amount of applications the other user has to navigate to listen to music while exercising. Other examples and benefits for incorporating an SDK that allows for inter-application communication can also be used.

The SDK frontend module can include one or more deployed SDKs that enable client device applications to communicate using the SDK server 102 (and/or the SDK backend). The client device applications can integrate the SDK frontend module with the corresponding deployed SDKs through an install, recompiling, and execution of the deployed SDKs. By installing the deployed SDKs in each of the client device applications, the SDK server 102 can enable different applications to communicate with another across different and the same client device.

System 101 is beneficial for a variety of reasons. By incorporating an SDK frontend module into a variety of applications, the SDK server 102 can ensure messages and/or notifications are delivered to various client devices, regardless of the identity of the applications installed on those devices. For example, it can be difficult to recruit users or participants to download a particular application or access a website when a company desires to reach a particular audience. Thus, by installing an SDK into applications provided to different client devices 106, the SDK server 102 can provide notifications to users of different client devices without the users having to download a specific application or access a particular website. Rather, in some cases, the SDK server 102 can install or deploy an SDK into an application requested for by a user of the client device. The requested application can be useful because this ensures with a high likelihood of confidence that a notification provided through the SDK can reach the user, since the user has interest in requesting a downloaded application.

In some implementations, the SDK server 102 can enable various communications in response to deploying applications with the incorporated SDK to each respective client device. For example, as illustrated in system 101, the application 112-1 of client device 106-1 can now communicate with application 112-N of client device 106-N. Similarly, the application 112-1 if client device 106-1 can also communicate with application 112-2 of client device 106-2. For example, the application 112-1 may be a social media application, the application 112-N may be a finance application, and the application 112-2 may be a health application. The three applications 112-1, 112-2, and 112-N can communicate with one another by way of the SDK server 102. Typically, application 112-1 communicates with a similar application on another client device through backend application server 108-1. Now, with the installed SDK incorporated in each application, the application 112-1 may communicate directly with a different application on a different client device, e.g., applications 112-2 and 112-N, or with a different application on a similar client device without relying on backend application server 108-1 as the communication medium.

Similarly, the applications 112-N and 112-2 can also communicate with one another through the SDK server 102. Although these applications may be different and incorporate different functionality, their respective SDKs, e.g., SDK 110-N and SDK 110-2, enable both applications to communicate with one another. Other applications that have incorporated the SDK received from the SDK server 102 can also communicate with different applications on the same client device or on different client devices.

In some implementations, the applications that incorporate the SDK can provide different data to one another. Specifically, the applications that have incorporated the SDK can provide data, messages, notifications, video, audio, financial transactions, links, data objects, functional features of the transmitting application to now be incorporated by the recipient application, and other various features. For example, the financial application of application 112-1, with the incorporated SDK, may seek to transmit data identifying a particular stock or ETF to a social media application of application 112-N for research information. The user of client device 106-1 may be an avid financial guru and may have prior knowledge that user of client device 106-N does not open any applications other than their social media application. As such, the user of client device 106-1 may seek to get user of client device 106-N involved in finances, and as such, transmits financial stock information to the social media application (application 112-N) of client device 106-N. The user of client device 106-N can receive the financial stock information through their social media application by way of SDK 110-N and read such financial information. In response, the user of client device 106-N can provide a message back to the user associated with client device 106-1 by way of SDK 110-1 through their financial application (application 112-1) requesting to please provide more financial information. Other examples are also possible.

In another example, the application 112-2 may be a social media application and the application 112-1 may be a financial application for a relevant user. The user of client device 106-2, e.g., associated with the social media application, may wish to send a user of client device 106-1, e.g., associated with the financial application, a video of a new product that has recently been advertised on the social media application. The transmitting user of the video from client device 106-2 may wish for the user of client device 106-1 to view the video because they can immediately purchase stock in the company that is advertising the new product, without having to switch to their own social media application. Rather, the user of client device 106-1 can immediately view the received video through their financial application, e.g., the application 112-1, and take quick action to purchase stock in the new product. This quick and efficient communication mechanism reduces time wasted by users of client devices by preventing them from switching between different applications on their respective client device. The information from the social media application on client device 106-2 is directly presented on their financial application on client device 106-1.

In another example, a son using client device 106-1 may be watching a movie on a video application, e.g., application 112-1. A father using client device 106-N may be using a calendar application, e.g., application 112-N. In this example, each application includes the deployed SDK, e.g., SDK 110-1 and SDK 110-N. The father may notice that the time has come for the son to stop watching the movie and do his homework. The father can send a notification through the calendar application on client device 106-N to the video application on client device 106-1 indicating that it is time for the son to do their homework. The notification may be presented on or through the video application of the client device 106-1 and present the notification to the son. Rather than the son having to switch applications to view the notification, which the son most likely ignores because he is watching a movie, the son can view the notification directly on or through the video application and stop watching the movie. Other examples in system 100 are also possible.

In some implementations, the communications between the various applications can be passed through the SDK server 102. When a particular application of client device transmits data to another application through their respective SDK, that data is passed through the SDK server 102, which acts a conduit before the data is provided to the recipient. In one such example, the application 112-1 on client device 106-1 seeks to transmit information to the application 112-2 on client device 106-2. To do this, the application 112-1 transmits the data using SDK 110-1 to the SDK server 102, and subsequently, the SDK server 102 transmits the data to the SDK 110-2 on client device 106-2, where the data is received by the application 112-2. In some implementations, the communications between the various applications may bypass the SDK server 102 and communicate over a network between two different SDKs.

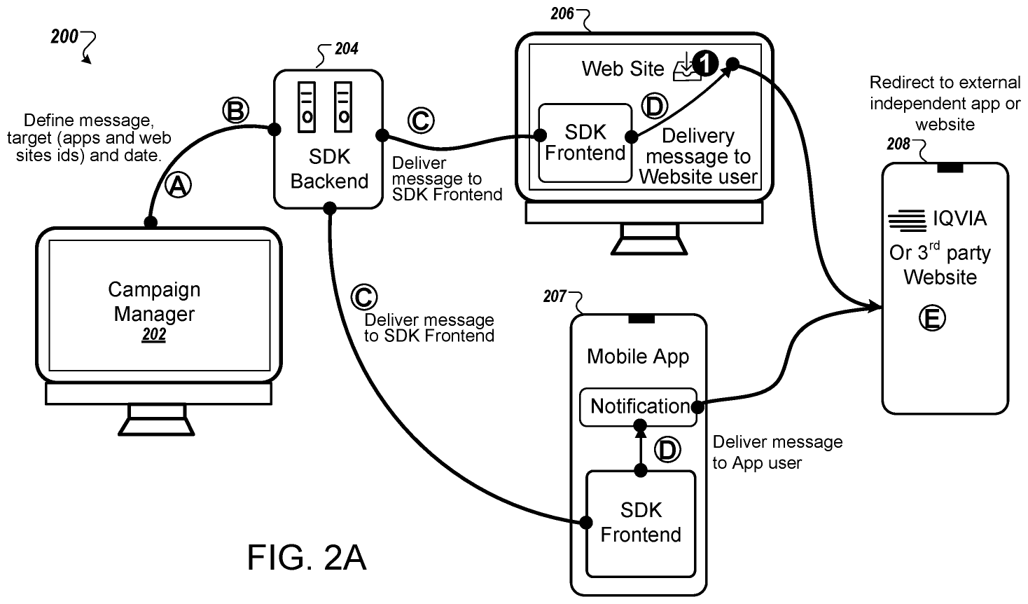

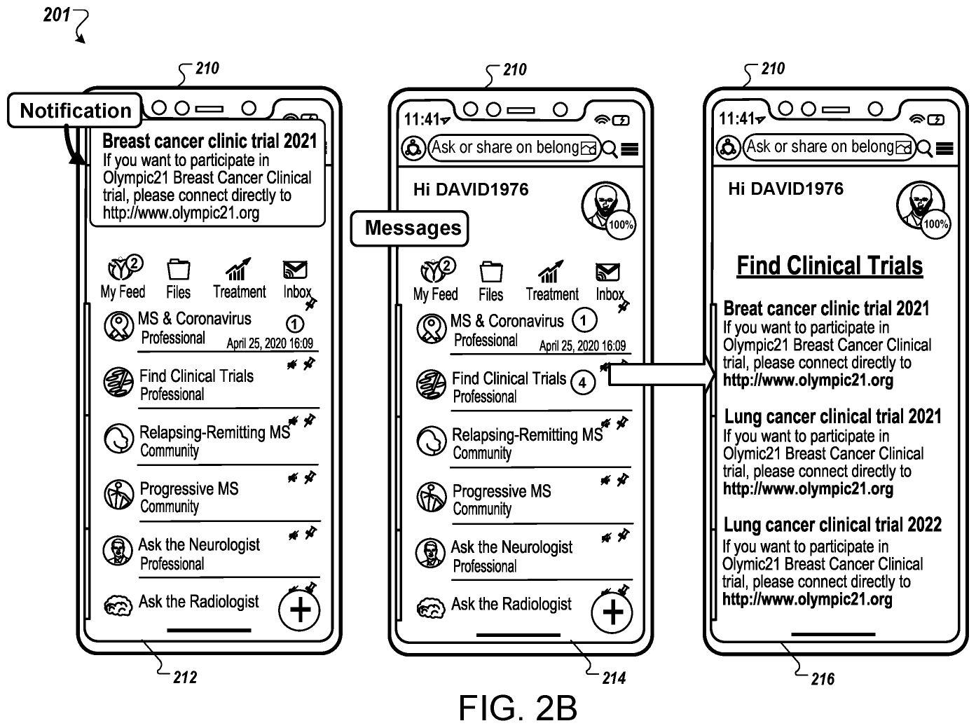

FIG. 2A is a flow diagram that illustrates an example of a process 200 for distributing a message to applications and websites that include the deployed SDK. The SDK server 202 can perform the process 200. The SDK server 202 can be a similar server to SDK server 102, as illustrated and described in system 100. The process 200 describes a distribution of data to various devices, applications, and/or websites. FIG. 2A illustrates various operations in stages (A) through (E), which may be performed in the sequence indicated, in another sequence, with additional stages, and with fewer stages.

During stage (A), the SDK server 202 can determine a message to broadcast to specified applications that include the incorporated SDK. Specifically, the SDK server 202 can identify a list of applications that include the incorporated SDK by way of the stored application IDs, such as those listed in data 104 from system 100. For example, the SDK server 202 can identify the list of application IDs and device IDs that it desires to transmit and provide this information to the SDK backend 204, which will be further described below.

In some implementations, the specified applications can include each of the applications in the list or a subset of the applications in the list. The list can include application identifiers and corresponding application data types, e.g., medical or exercise applications, for distributing the message for broadcasting. For example, the SDK server 202 can select a particular cohort from a group of application identifiers, e.g., only medical applications or only exercise applications from the list of applications, and broadcast the message to those specified applications.

The message to be broadcasted can include a notification or an alert. For example, the message can include “Patient testing location changed to stadium at 4:00 PM ET.” In another example, the message can recite “Please select this link to fill out the survey: https://testsurvey.” In another example, the message can recite, “Please restart your client devices to receive the latest software updates. The messages and their content can vary, depending on the intent of the broadcast distribution from the SDK server 202.

The messages and content can also include a date for when to distribute the broadcast message. For example, the SDK server 202 can determine that a message should be broadcasted at 4:30 PM on Tuesday. In another example, the SDK server 202 can determine that a message should be broadcasted at a first time, e.g., 2:30 PM, but that the recipient should not be notified until a second time, e.g., 5:00 PM, on the same day. This may be the case when the broadcaster seeks to send out a test scenario to ensure the broadcasting functionality is operating properly or to ensure that a message has arrived at the application when the broadcaster knows the recipients' client devices are powered off. Other examples are also possible.

During stage (B), the SDK server 202 can deliver the broadcasted message, the recipients' application and device identifiers, and a date/time when to broadcast the message to the recipients to an SDK backend 204. The SDK backend 204 can include one or more computers connected locally or over a specific network. Specifically, the SDK backend 204 can use the received information to identify address information of the recipients and distribute the message to the applications based on the recipients' address information.

Specifically, the SDK backend 204 can identify a recipient using the received device and application identifiers. The SDK backend 204 can store a list of profiles that include data identifying the client devices, data identifying the users of the client devices, device identifiers, application identifiers, website identifiers, validation information associated with the client device, and other information. This information can be stored in memory or in one or more databases. The SDK backend 204 can use the device identifiers and the application identifiers as indices to retrieve one or more profiles of the intended recipients. For example, the profile for a particular user can include address information that includes IP addresses, MAC addresses, email addresses, and other address information identifying the application on a specific client device. The SDK backend 204 can retrieve these profiles based on the application and device identifiers, extract the address information from the retrieved profiles, and deliver the broadcasted messages to the applications at the specified date and time.

During stage (C), the SDK backend 204 can deliver the broadcasted messages to the SDK frontend module of each identified application. The address information of the specified client device and application, which includes the SDK frontend module, is available to the SDK backend 204. Based on the identified address information, the SDK backend 204 can broadcast the particular message to the SDK frontend module of the corresponding client device application. As illustrated in process 200, the SDK backend 204 can broadcast the message to an SDK frontend module included in a website 206 and to another SDK frontend module included in a mobile device application 207. The message can be transmitted over a large network, such as the Internet, or over a short-range network, such as Bluetooth, to name a few examples.

During stage (D), the SDK frontend module of the website 206 and the mobile device application 207 can receive the message delivered by the SDK backend 204. In some implementations, the SDK frontend module in the website 206 and the mobile device application 207 can deliver the message to the user in response to receiving the message from the SDK backend 204. In some implementations, the SDK frontend module in both the website 206 and the mobile device application 207 can deliver the notification at a later point in time.

The notification or message can be delivered to the user later based on one or more characteristics. For example, the SDK frontend module can deliver the notification to the user based on a future date and time specified by the instructions provided by the SDK server 202, and subsequently the SDK backend 204. In another example, the SDK frontend module can deliver the notification to the user based on a particular locations specified by the instructions provided by the SDK server 202. In this example, the instructions can indicate that when the corresponding client device's locations reach a certain location or are within a certain radius of a certain location, then the notification is to be delivered to the user. Delivering the notification to the user can be provided, for example, in the form of a push notification, an email, a text message, a telephone call, a voicemail, and video message, to name a few examples.

During stage (E), in response to delivering the notification, the user has the ability to interact with the notification. For example, if the notification includes a link to an application, website, or some network that enables the user access to view additional information, then the user can select or interact with the link. In some implementations, the interacted notification can redirect the application the user's client device to an external independent application or to another website. In some implementations, the notification may display a message that does not lead to an external independent application or to another website.

FIG. 2B is another flow diagram that illustrates an example of user interfaces 201 for distributing a message to applications and websites that include the deployed SDK. The depicted user interfaces 201 illustrate notifications that may be displayed to the user in response to the process 200 performed from FIG. 2A. Specifically, FIG. 2B illustrates a client device 210 and different user interfaces 212, 214, and 216 in response to the process 200 performed.

Specifically, the user interface 212 illustrates that the user has a notification on their client device 210 while operating within a messaging application. The messaging application can include the deployed SDK. The user interface 212 illustrates a notification that recites, “Breast Cancer Clinic trial 2021—If you want to participate in Olympic21 Breast Cancer Clinical Trial, please connect directly to http://www.olympic21.org.” The user can interact with the notification on the user interface 212 to access the content in the notification, e.g., the website for the Breast Cancer Clinical Trial. In another example, the client device 210 can display a user interface 214 which displays messages of distributed notifications. The user interface 214 can indicate that there is 1 message awaiting in the “MS & Coronavirus” inbox and there are 4 messages awaiting in the “Find Clinical Trials” inbox. The user can interact with either inbox to view the corresponding messages.

For example, the client device 210 can switch to user interface 216 in response to the user selecting the “Find Clinical Trials” inbox from the user interface 214. In response, the user can view the different clinical trials on the user interface 216. These clinical trials can include, for example, “Breast Cancer Clinic Trial 2021,” “Lung Cancer Clinical Trial 2021,” and “Lunch Cancer Clinical Trial 2022.” The user can select, from the user interface 216, which clinical trial to participate in by selecting the URL corresponding to each of the clinical trials, e.g., http://www.olympic21.org. Other interfaces are also possible for viewing different applications that have the deployed SDK and corresponding distributed notifications.

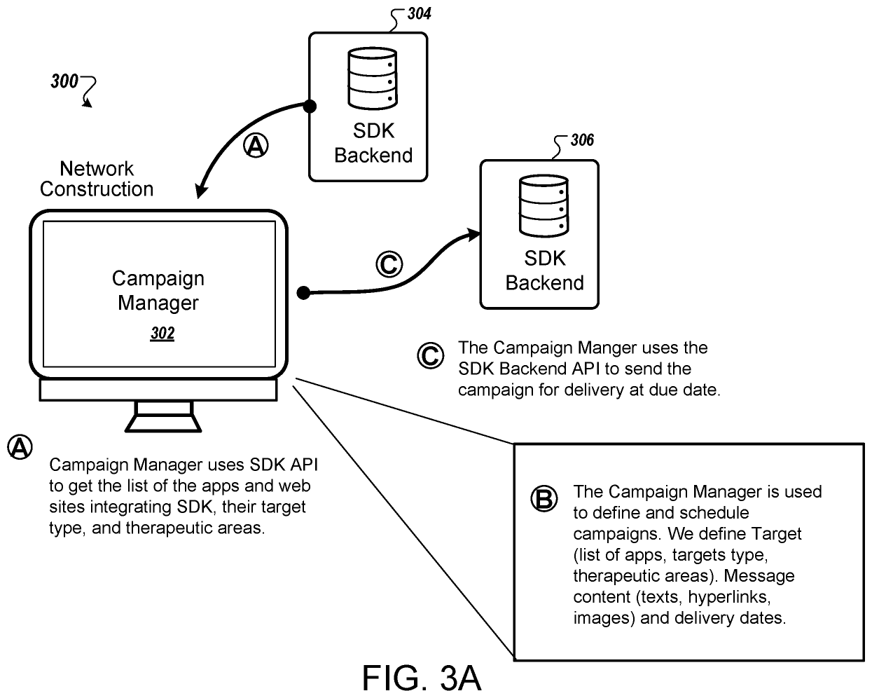

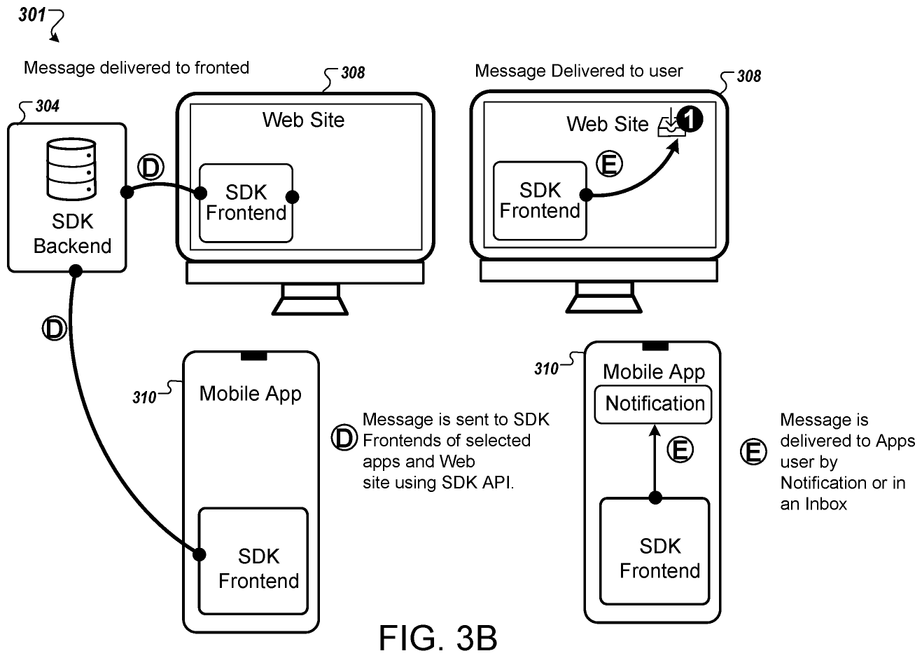

FIG. 3A is a flow diagram that illustrates an example of a process 300 for providing notifications to applications and websites that each include the incorporated SDK. The campaign manager 302 and the SDK backend 304 can perform the process 300. In some implementations, the campaign manager 302 can be a different system from the SDK server. The campaign manager 302 can include one or more computers connected locally or over a network, that communicate with the SDK server and the SDK backend 304. The campaign manager 302 can be used to define, schedule, and execute campaigns of broadcasted messages.

During stage (A), the campaign manager 302 can access the SDK backend 304 to identify various profiles as intended recipients of a broadcasting message. Specifically, the campaign manager 302 can identify various profiles of applications that have the incorporated SDK by utilizing an SDK API. The SDK API enables access to the SDK backend 304. Specifically, the SDK API can return one or more profiles to the campaign manager 302 by providing a target type of users to access and various content areas. In response, the campaign manager 302 can receive profiles from the SDK backend 304. The profiles can include a list of applications that have incorporated the SDK and meet the criteria input by the campaign manager 302 to the SDK API.

During stage (B), in response to receiving the list of applications that have incorporated the SDK, the campaign manager 302 can define a campaign. A campaign can be defined as a broadcast message delivery to recipients based on various criteria. The criteria can include a target type, message content, and delivery dates. For example, the target type can include intended targets or recipients. The intended targets or recipients can be identified based on those recipients participating in scheduled events, recipients who are patients under a particular care provider, the care providers, recipients involved who seek a potential treatment care, recipients who are involved in beta testing of software, and other recipients.

In some implementations, the message content can include types of information to provide in the broadcasted message. The types of information can include, for example, text messages, hyperlinks, images, videos, audio, access to other networks and other third party application, and other information. When the message is delivered to the recipient, the recipient can access and view the message content when the user is using the application with the incorporated SDK.

In some implementations, the campaign can also include delivery dates. The delivery dates include the date when the campaign message is to be distributed. Additionally, the delivery dates can include the date when the campaign message is to be distributed as well as the date when the notification is to be delivered to the user. For example, the campaign can distribute or broadcast the message on Jan. 1, 2023 at 12:00 PM ET. However, the user can be notified of the message via a notification on Jan. 2, 2023 at 11:00 AM ET. Other examples are also possible.

During stage (C), the campaign manager 302 uses the SDK backend 304 to execute the campaign at the due date. Specifically, the campaign manager 302 can deliver the broadcasted message, the recipients' application identifiers and device identifiers, and a date/time when to broadcast the message to the recipients to the SDK backend 304. The SDK backend 304 can use the use the received information to identify address information of the recipients and distribute the message to the applications and/or websites based on the recipients' address information. This stage is similar to stage (B) of process 200.

FIG. 3B is another flow diagram that illustrates an example of a process 301 for providing notifications to applications and websites that each include the deployed SDK. The SDK backend 304 and various client devices can perform the process 301. FIG. 3B illustrates various operations in stages (D) through (E), which may be performed in the sequence indicated, in another sequence, with additional stages, and with fewer stages.

During stage (D), the SDK backend 304 can deliver the broadcasted messages to SDK frontend module of each identified application in each client device. Specifically, the SDK backend 304 can use the application and device address information of the client device to broadcast a particular message to the SDK frontend module of the corresponding client device. For example, as illustrated in process 301, the SDK backend 304 can deliver the message to the SDK frontend module included in a website 308 of a client device and deliver the message to another SDK frontend module included in a mobile device application 310. This stage is similar to stage (C) of process 200.

During stage (E), the SDK frontend module of the website 308 and the mobile device application 310 can receive the message broadcasted by the SDK backend 304. In some implementations, the SDK frontend module integrated in the website 208 and the SDK frontend module integrated in the mobile device application 310 can deliver the message to the user in response to receiving the message from the SDK backend 304. In some implementations, the SDK frontend module in both the website 308 and the mobile device application 310 can deliver the notification at a later point in time. This stage is similar to stage (D) of process 200.

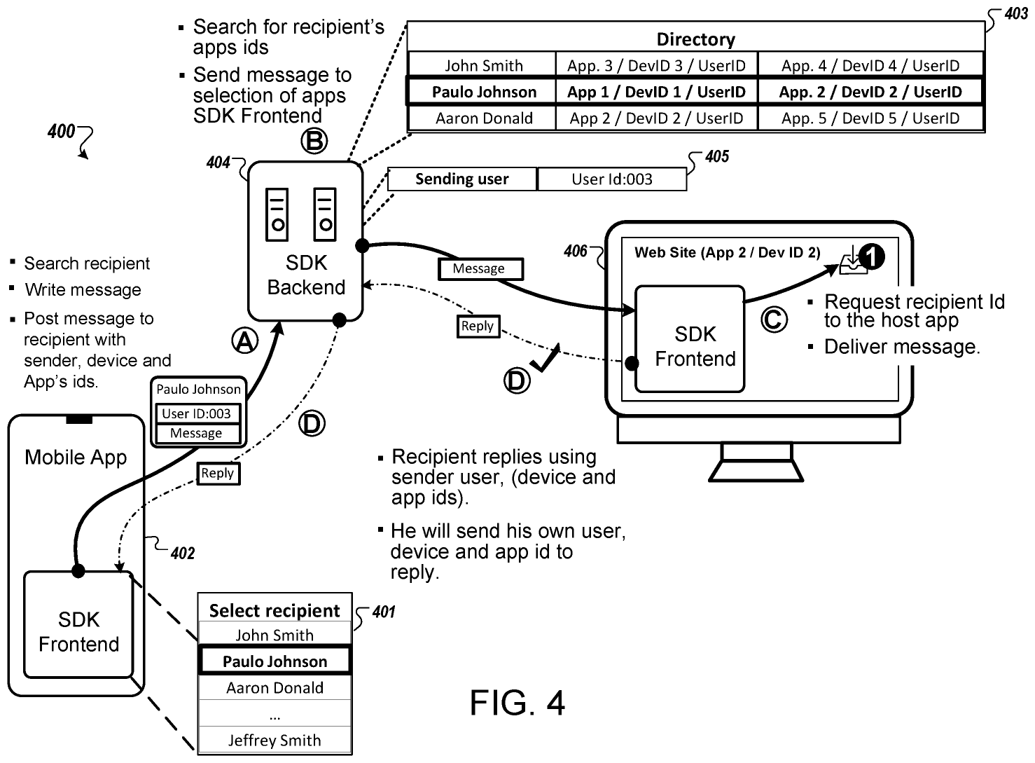

FIG. 4 is a flow diagram that illustrates an example of a process 400 for end-to-end communications between applications and websites that include the deployed SDK. One or more client devices, an SDK server, and an SDK backend 404 may perform the process 400. FIG. 4 illustrates various operations in stages (A) through (D), which may be performed in the sequence indicated, in another sequence, with additional stages, and with fewer stages.

During stage (A), a user associated with client device 402 may request to transmit a message to another user associated with another client device 406. The user associated with the client device 402 may utilize a first application that has incorporated the SDK frontend module. For example, the first application can be a social media application, which has installed or incorporated the SDK frontend module as one of its software components. The user may desire to send the message to the other user with the client device 406 for a variety of reasons.

One such reason may include, for example, a recommendation to listen to music. In another example, the user of client device 402 may be using a video application that stores recorded videos, and desires to send a particular video to user of client device 406 on a financial application. The video may provide recommendations regarding which stocks or ETFs to purchase. In another example, the user of client device 402 may be a healthcare provider and desire to transmit a questionnaire to user of client device 406, who is the patient. The user of client device 402 may be using a questionnaire builder application on the client device 402 and the user of client device 406 may be using a health application on the client device 406. In this example, the questionnaire may be directly sent from the questionnaire builder application on client device 402 to the health application on the client device 406 by way of the SDK frontend modules incorporated in both applications.

In some implementations, the user of client device 402 may identify one or more recipients of the message. The SDK frontend module in the application on the client device 402 may display a user interface that enables the user to identify a recipient. For example, the client device 402 can display a user interface 401 displays different users to select from, e.g., John Smith, Paulo Johnson, Aaron Donald, Jeffrey Smith, and others. The user can search for a recipient by entering in data identifying the recipient. The data can include, for example, a name of the recipient, an application used by the recipient that includes the SDK frontend module, an application identifier of the recipient, a device identifier recipient. In some implementations, the user interface can display results of applications that have incorporated the SDK frontend module. For example, in response to providing data identifying the recipient, the SDK frontend module of the client device 402 can transmit a request to the SDK backend 404. The SDK backend 404 can receive the request and identify a list of recipients that match or partially match to the user interface on the client device 402. In response, the user can select the correct recipient displayed from the list of user interfaces. For example, the user of client device 402 can select Paulo Johnson of the user interface 401, as illustrated in system 400. Paulo Johnson can correspond to the owner of client device 406. In some implementations, each SDK frontend module can store the list of recipients that include the SDK frontend module to allow for quick access to one or more recipients.

In response to selecting a recipient, e.g., Paulo Johnson, the SDK frontend module of the client device 402 can transmit data indicative of the message to the recipient. Specifically, the SDK frontend module of the client device 402 can transmit the message data from the respective application with the sender information, e.g., sender application identifier, user identifier, and device identifier, the message itself, and the recipient information, e.g., a name or application identifier of the recipient. The SDK frontend module of the client device 402 can transmit the message data over a long-range network or a short-range network to the recipient through the SDK backend 404.

During stage (B), the SDK backend 404 can receive the data indicative of the message transmitted by the SDK frontend module of the client device 402. In some implementations, the SDK backend 404 can identify additional recipient information using the data indicative of the message. For example, the SDK backend 404 can identify one or more profiles using the recipient information provided in the data indicative of the message. As illustrated in system 400, the SDK backend 404 can access a directory 403. The directory 403 can include recipient information for a variety of applications that include the SDK frontend module. Additionally, the recipient information can include a name identifying the recipient or an application identifier identifying the recipient. The SDK backend 404 can identify one or more recipients using the name, application identifier of the recipient, or other data identifying the recipient as an index into one or more databases storing information about recipients to retrieve one or more user profiles. The SDK backend 404 can retrieve the one or more user profiles, extract application identifiers, device identifiers, and addresses of the recipients. For example, the SDK backend 404 can identify Paulo Johnson from the directory 403, the application identifier 1, a corresponding device ID 1, and a user ID. Similarly, the user Paulo Johnson may be linked to one or more different applications, e.g., application identifier 2, device identifier 2, and user ID. In response, the SDK backend 404 can transmit the message provided by the SDK frontend module of the client device 402 to the one or more SDK frontend modules of the client devices identified from the one or more user profiles. For example, the SDK backend 404 can transmit the message provided by the SDK frontend module of the client device 402 to the one or more SDK frontend modules of the applications based on the user profile of Paulo Johnson. The message can be broadcasted to the one or more SDK frontend modules that match to the recipient(s) over a network.

During stage (C), the one or more SDK frontend modules can receive the message from the SDK backend 404. Each of the one or more SDK frontend modules can be incorporated into a particular application, as previously described. As illustrated in process 400, the SDK frontend module that received the message can be incorporated in a particular website, e.g., a financial website, a healthcare website, or other. In response to receiving the message, the SDK frontend module in the client device 406 can provide the message to the user in the corresponding client device application. The message can be provided as, for example, a notification, an email, a message, a pop-up, a video, an audio message, or some other form of message.

During stage (D), the user of client device 406 may respond to the message sent by the user of client device 402. Specifically, when the user of client device 406 receives the message from the SDK frontend module incorporated in the application on client device 406, the SDK frontend module can display a user interface that enables the user of client device 406 to respond to the user that transmitted the message. The user of client device 406 can respond with, for example, another message, a filled out questionnaire, a confirmation message, a video message, an audio message, or some other response.

In response to entering the message, the SDK frontend module of the client device 406 can transmit data indicative of the response message to the SDK backend 404. The data indicative of the response message can include, for example, the response message, data identifying the sending SDK frontend in application of client device 406, e.g., application identifier of application with SDK frontend in client device 406, data identifying the device identifier of client device 406, data identifying the user associated with client device 406, and data identifying the recipient, e.g., application identifier of application with SDK frontend in client device 402, data identifying the device identifier of client device 402, data identifying the user associated with client device 402. The data indicative of the response message can be sent over a network to the SDK backend 404.

The SDK backend 404 can receive the data indicative of the response message. In some implementations, the SDK backend 404 can identify the recipient based on the data identifying the recipient in the received response. The recipient can be identified and the SDK backend 404 can determine address information of the recipient, e.g., SDK frontend in application of client device 402, by pulling profile information from the database. In some implementations, the data indicative of the response message sent by the SDK frontend module of the client device 406 does not include the data identifying the recipient. Rather, the SDK backend 404 can maintain a tracking log that identifies a sender and one or more recipients. In this case, should the recipient respond to the SDK backend 404, the SDK backend 404 can identify the sender by way of their application and device identifiers and forward the response message to the sender based on their application and device identifiers. For example, the SDK backend 404 maintains a tracking log 405 that includes information identifying the transmitting user of client device 402, so the SDK backend 404 can determine how to respond to reply messages from the client device 406. The information identifying the transmitting user can also include, for example, an application identifier, a device identifier, a timestamp when the message was received during stage (A), and information identifying the user associated with the transmitted client device, e.g., client device 402. Generally, the SDK backend 404 can forward the message to the recipient, e.g., SDK frontend module of the application in the client device 402, in response to receiving the message from client device 406.

In some implementations, the SDK frontend module of the application in the client device 402 can receive the response and take action. Specifically, the SDK frontend module of the application in the client device 402 can display the response to the user associated with the client device 402, by way of a user interface or some other notification. The user can review the response and decide whether to respond to the specific sender or whether to rebroadcast a new message to one or more recipients.

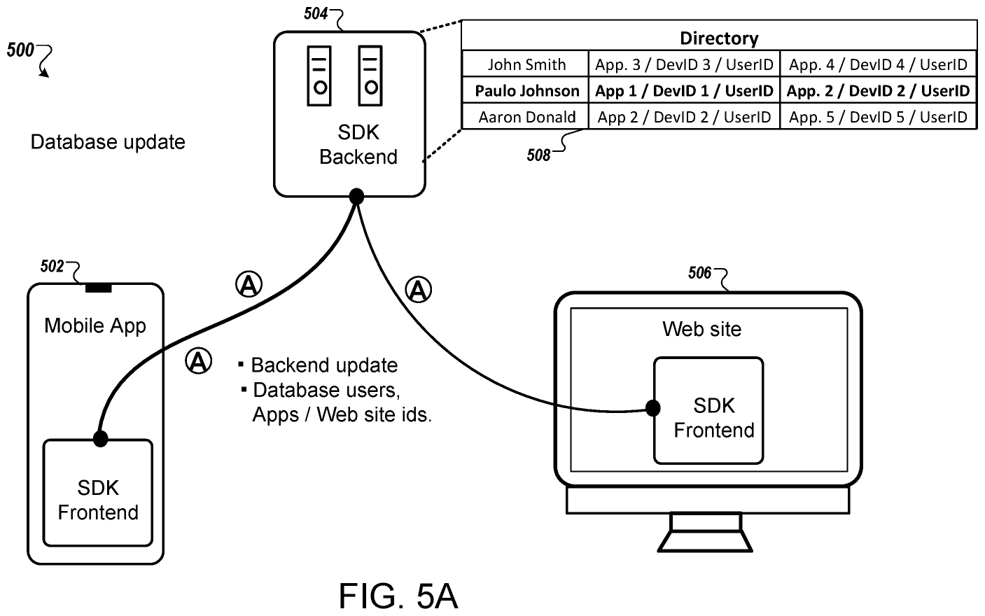

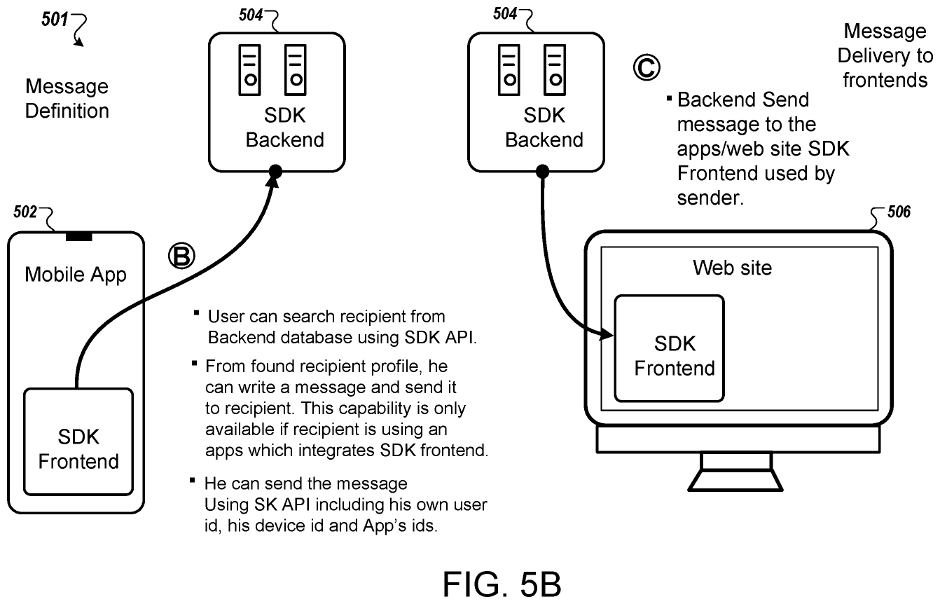

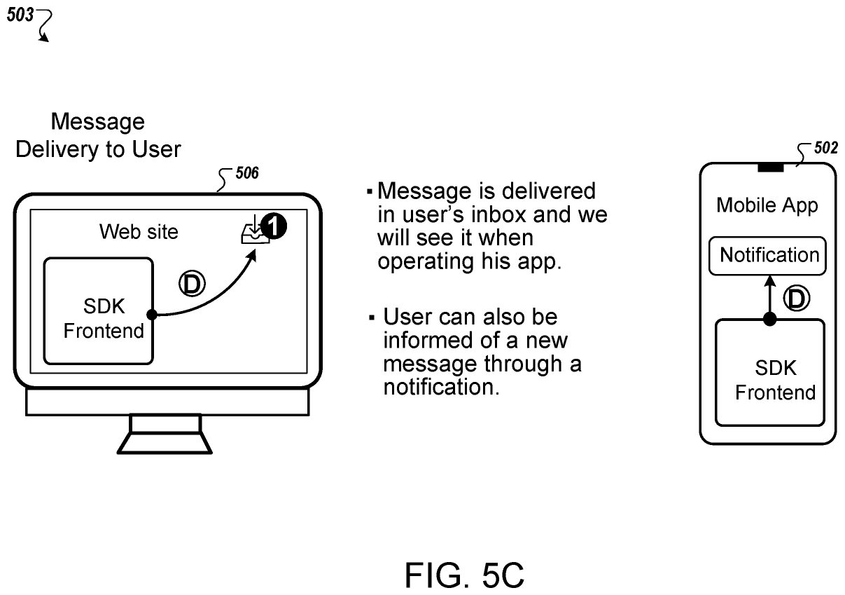

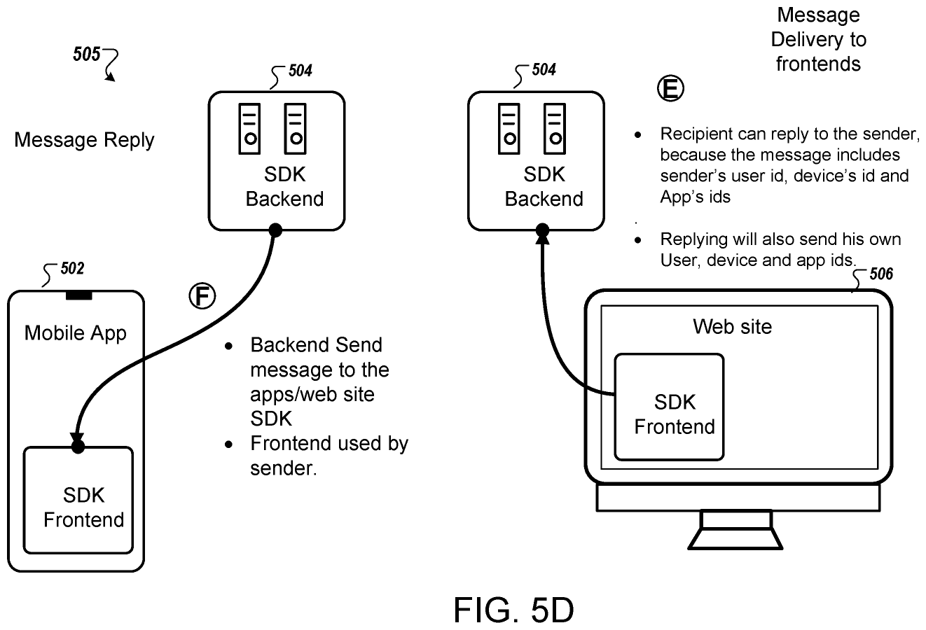

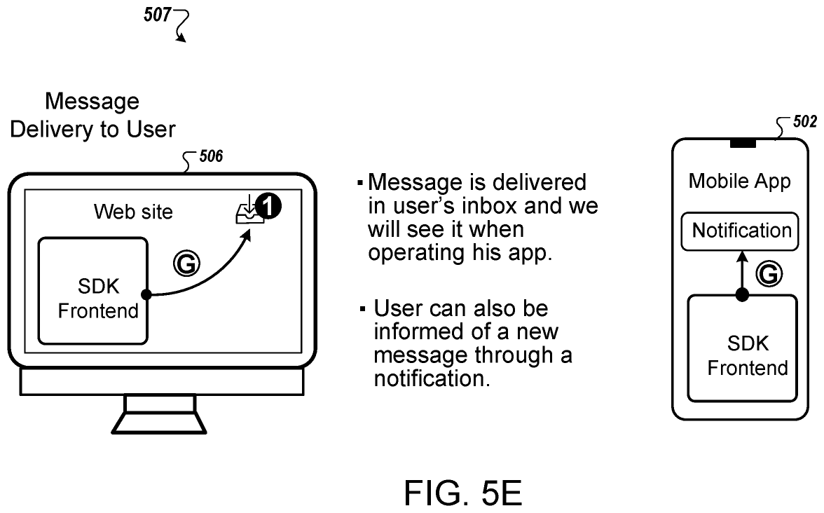

FIG. 5A is a flow diagram that illustrates an example of a process 500 for an application to bi-directionally communicate with a specified application that includes the deployed SDK. One or more client devices and an SDK backend can perform the process 500. Specifically, the process 500 illustrates an update process for device and application identifiers. The process 500 can illustrate a stage (A), which may be performed with additional stages.

During stage (A), the SDK backend 504 may receive an update to one of its entries. Specifically, as previously discussed, the SDK backend 504 may include one or more databases that store user profiles. For example, the SDK backend 504 can include a directory 508. The directory 508 can include user profiles that include information regarding application identifiers, device identifiers, and other address information. In one example, the SDK backend 504 may receive an update to one of its user profiles. on the specific client device, the user can utilize the features of the revised application and the revised SDK.

FIG. 5B is another flow diagram that illustrates an example of a process 501 for an application to bi-directionally communicate with a specified application that includes the deployed SDK. One or more client devices and an SDK backend can perform the process 501. Process 501 is a continuation of process 500. FIG. 5B can illustrates stages (B) through (C), which may be performed in the sequence indicated, in another sequence, with additional stages, and with fewer stages.

During stage (B), the user of client device 502 may desire to transmit a message to another user associated with another client device 506. The user associated with client device 502 may utilize a first application that has incorporated the SDK frontend module. Specifically, the SDK frontend module of the client device 502 may display a user interface that enables the user to identify a recipient. The user can search for a recipient by entering data in the user interface that identifies the recipient by either a partial match or a full match. In response, the user can select the correct recipient and can send a message to the recipient's application that has incorporated an SDK frontend module. The user of client device 502 can send a message that includes, for example, text, video, audio, a questionnaire, a hyperlink, or some other form of data. Stage (B) is similar to stage (A) of process 400.

The SDK frontend module of the client device 502 can transmit data indicative of the message to the recipient. Specifically, the SDK frontend module of the client device 502 can transmit the message data from the respective application with the sender information, e.g., sender application identifier, user identifier, and device identifier, the message itself, and the recipient information, e.g., a name or application identifier of the recipient. The SDK frontend module of the client device 502 can transmit the message data over a long-range network or a short-range network to the recipient through the SDK backend 504.

The SDK backend 504 can receive the data indicative of the message transmitted by the SDK frontend module of the client device 502. The SDK backend 504 can identify address information from the recipient information included in the message. In response, the SDK backend 504 can transmit the message provided by the SDK frontend module of the client device 502 to the one or more SDK frontend modules of the client devices identified from the one or more user profiles. The message can be transmitted to the one or more SDK frontend modules that match to the recipient(s) over a network.

During stage (C), the SDK frontend module of a website of client device 506 can receive the transmitted message from the SDK backend 504. The SDK frontend module of the website can receive the transmitted message when the website is not currently in use. In response to receiving the transmitted message, the SDK frontend module in the website of the client device 506 can deliver the message to the user on the website. Stage (C) is similar to stage (B) of process 400.

FIG. 5C is another flow diagram that illustrates an example of a process 503 for an application to bi-directionally communicate with a specified application that includes the deployed SDK. Process 503 is a continuation of processes 500 and 501. One or more client devices can perform the process 503. FIG. 5C illustrates a stage (D), which may be performed with additional stages.

During stage (D), the SDK frontend module in the website of client device 506 may provide a notification to the user of the received message. The SDK frontend module may provide the message to the user associated with client device 506 on the website in a variety of manners. The message can be provided as, for example, a notification on the website, an email in their inbox, a message or message notification, a pop-up, a video, an audio message, or some other form of message. Other examples are also possible.

FIG. 5D is another flow diagram that illustrates an example of a process 505 for an application to bi-directionally communicate with a specified application that includes the deployed SDK. Process 505 is a continuation of processes 500, 501, and 503. One of more client devices and an SDK backend can perform the process 505. FIG. 5D illustrates various operations in stages (E) through (F), which may be performed in the sequence indicated, in another sequence, with additional stages, and with fewer stages.

During stage (E), the recipient of the message can respond to the sender because the transmitted message can include the sender's user identifier, device identifier, and application identifier. Specifically, the recipient, e.g., user of client device 506, can reply to the transmitted message with a message of his or her own. The message can include, for example, a text message, a video message, a filled out questionnaire, a confirmation, an audio message, a hyperlink, or some other response. The SDK frontend module of the website of client device 506 can transmit data indicative of the response message to the SDK backend 504. The data indicative of the response message can include, for example, the response message, data identifying the sending SDK frontend in application of client device 506, e.g., application identifier of application with SDK frontend in client device 506, data identifying the device identifier of client device 506, data identifying the user associated with client device 506, and data identifying the recipient, e.g., application identifier of application with SDK frontend in client device 502, data identifying the device identifier of client device 502, data identifying the user associated with client device 502.

In some implementations, the recipient and sender can change when the previous recipient responds to the sender. For example, initially in process 501, client device 502 is the sender and client device 506 is the recipient. Then, when client device 506 responds to the client device 502 as shown in process 505, then client device 506 becomes the sender and client device 502 becomes the recipient.

During stage (F), the SDK backend 504 can receive the data indicative of the response message from the SDK frontend module in the application of client device 506. Specifically, the SDK backend 504 can identify the new recipient of the received message, e.g., SDK frontend module of application of client device 502. In response, the SDK backend 504 can transmit the response message to the SDK frontend module of the application in client device 502. Stages (E) and (F) are similar to stage (D) from process 400.

FIG. 5E is another flow diagram that illustrates an example of a process 507 for an application to bi-directionally communicate with a specified application that includes the deployed SDK. Process 507 is a continuation of processes 500, 501, 503, and 505. One or more client devices can perform the process 505. FIG. 5E illustrates various operations in stage (G), which may be performed in the sequence indicated, in another sequence, and with additional stages.

During stage (G), the SDK frontend module of the application in client device 502 can receive the response message from the SDK backend 504. In response, the SDK frontend module of the application in client device 502 can display the response message to the user associated with the client device 502. The response message can be displayed as a notification, such as the notification illustrated in FIG. 5E on client device 502, or can be provided to the user's inbox and the user can see the notification when operating the corresponding application that includes the SDK frontend module, as illustrated in FIG. 5E on client device 506. The user can review the response message and decide whether to respond to the specific sender or whether to transmit a new message to one or more recipients.

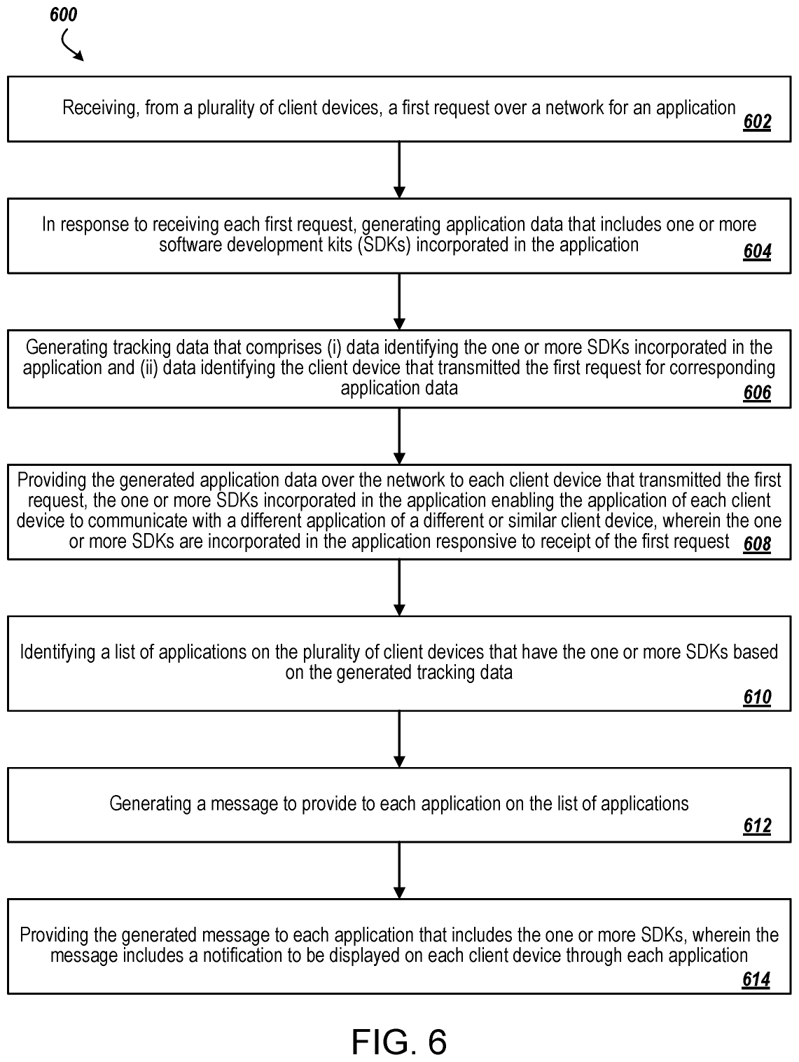

FIG. 6 is a flow diagram that illustrates an example process 600 for enabling end-to-end communications between different applications on various client devices. SDK servers 102, 202, and 302 can perform the process 600.

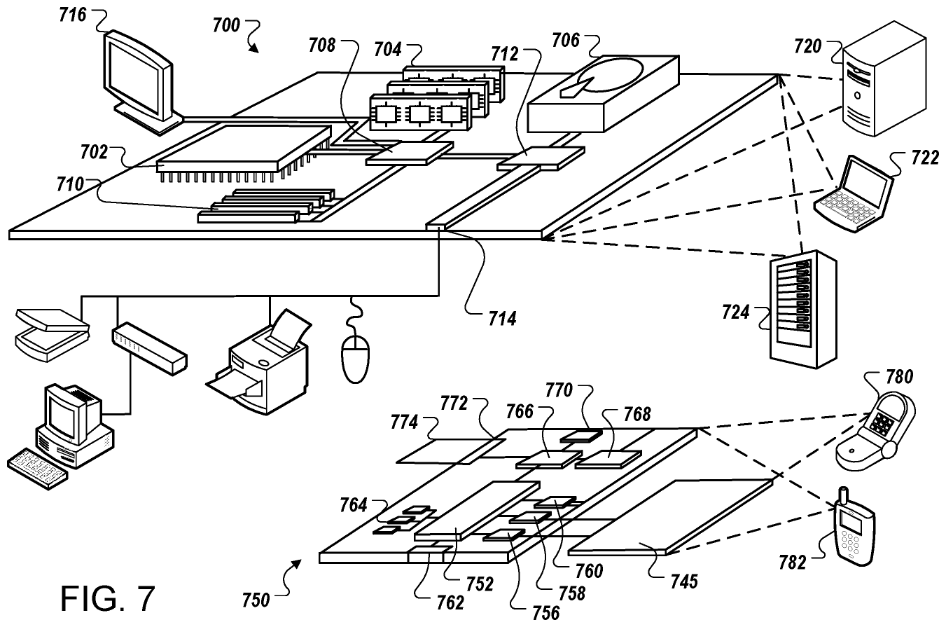

FIG. 7 is a block diagram of computing devices 700, 750 that may be used to implement the systems and methods described in this document, either as a client or as a server or multiple servers. Computing device 700 and 750 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations, e.g., as a server bank, a group of blade servers, or a multi-processor system.

The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 1400. In one implementation, the storage device 706 is a computer-readable medium. In various different implementations, the storage device 706 may be a floppy disk device, a hard disk device, an optical disk device, or a tape device, a flash memory or other similar solid-state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer-or machine-readable medium, such as the memory 704, the storage device 706, or memory on processor 702.

The high-speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716, e.g., through a graphics processor or accelerator, and to high-speed expansion ports 710, which may accept various expansion cards (not shown). In the implementation, low-speed controller 712 is coupled to storage device 706 and low-speed expansion port 714. The low-speed expansion port, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication, e.g., via a docking procedure, or for wireless communication, e.g., via Bluetooth or other such technologies.

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound, e.g., voice messages, music files, etc., and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a backend component, e.g., as a data server, or that includes a middleware component such as an application server, or that includes a front-end component such as a client computer having a graphical user interface or a Web browser through which a user can interact with an implementation of the systems and techniques described here, or any combination of such backend, middleware, or front-end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, certain data may be treated in one or more ways before it is stored or used, so that personally identifiable information is removed. For example, in some embodiments, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A number of embodiments have been described. Nevertheless, it will be understood that various modifications may be made without departing from the spirit and scope of the invention. Accordingly, other embodiments are within the scope of the following claims. While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment.

Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer system-implemented method comprising:
receiving, by one or more processors and from a plurality of client devices, a first request over a network for an application;
in response to receiving each first request, generating, by the one or more processors, application data that includes one or more software development kits (SDKs) incorporated in the application;
generating, by the one or more processors, tracking data that comprises (i) data identifying the one or more SDKs incorporated in the application and (ii) data identifying the client device that transmitted the first request for corresponding application data;
providing, by the one or more processors, the generated application data over the network to each client device that transmitted the first request, the one or more SDKs incorporated in the application enabling the application of each client device to communicate with a different application of a different or similar client device, wherein the one or more SDKs are incorporated in the application responsive to receipt of the first request;
identifying, by the one or more processors, a list of applications on the plurality of client devices that have the one or more SDKs based on the generated tracking data;
generating, by the one or more processors, a message to provide to each application on the list of applications; and
providing, by the one or more processors, the generated message to each application that includes the one or more SDKs, wherein the message includes a notification to be displayed on each client device through each application.

2. The computer system-implemented method of claim 1, wherein generating the application data that includes the one or more SDKs further comprises generating, by the one or more processors, identifying, by the one or more processors, the one or more SDKs based on an operating system of the client device which transmitted the first request.

3. The computer system-implemented method of claim 1, further comprising:
receiving, by the one or more processors, a second request from a first application of a first client device to communicate with a second application of a second client device, wherein the first application includes the one or more SDKs;
determining, by the one or more processors, whether the second application of the second client device includes the one or more SDKs; and
in response to determining that the second application of the second client device includes at least the one or more SDKs, providing, by the one or more processors, an indication to the first application that enables the first application to communicate with the second application.

4. The computer system-implemented method of claim 1, further comprising:
receiving, by the one or more processors, a second request from a first application of a first client device to communicate with a second application of a second client device, wherein the first application includes the one or more SDKs;
determining, by the one or more processors, whether the second application of the second client device includes the one or more SDKs; and
in response to determining that the second application of the second client device does not include the one or more SDKs, providing, by the one or more processors, an indication to the first application that precludes the first application from communicating with the second application.

5. The computer system-implemented method of claim 1, further comprising:
receiving, by the one or more processors, a third request from a first application of a first client device to communicate with a second application of the first client device, wherein the first application includes the one or more SDKs;
determining, by the one or more processors, whether the second application of the first client device includes the one or more SDKs; and
in response to determining that the second application of the first client device includes at least the one or more SDKs, providing, by the one or more processors, an indication to the first application that enables the first application on the first client device communicate with the second application on the second client device.

6. The computer system-implemented method of claim 1, wherein the tracking data comprises a user identifier, a client device identifier, an application identifier, and the one or more SDKs for the application of the respective client device.

7. The computer system-implemented method of claim 1, wherein providing the generated message to each application that includes the one or more SDKs further comprises providing, by the one or more processors, the message to each of the one or more SDKs of each application on each client device, wherein the message comprises at least one of a text message, a hyperlink, and an image.

8. The computer system-implemented method of claim 1, wherein providing the generated message to each application that includes the one or more SDKs further comprises providing, by the one or more processors, the message to each of the one or more SDKs of each application on each client device when the client device is powered off, and enabling a user of the client device to receive a notification of the message when the respective client device is powered on.

9. The computer system-implemented method of claim 1, wherein generating a message to provide to each application on the list of applications further comprises generating, by the one or more processors, the message to provide to each application on the list of applications such that each application shares a similar backend server to enable communications between different applications of similar and different client devices.

10. The computer system-implemented method of claim 1, wherein generating the message to provide to each application on the list of applications further comprises generating the message to provide to each application on the list of applications to be displayed at a future date and future time.

11. The computer system-implemented method of claim 1, further comprises:
providing, by the one or more processors, a user interface that displays (i) the list of applications that incorporates the one or more SDKs on each client device, (ii) a number of requests transmitted and received from each of the one or more SDKs on each application of each client device, and (iii) a type of the one or more SDKs.

12. The computer system-implemented method of claim 11, further comprising:
in response to receiving the first request over the network for the application, determining, by the one or more processors, a validation of the client device for receiving the application with the incorporated one or more SDKs, wherein the validation comprises at least one of:
determining, by the one or more processors, whether the client device has sufficient memory for utilizing the application with the incorporated one or more SDKs;
determining, by the one or more processors, whether the client device has an operating system that matches to an operating system designated for the incorporated one or more SDKs; and
determining, by the one or more processors, whether technical components of the client device can (i) utilize the one or more SDKs and (ii) receive and transmit messages from different applications of other client devices and the same client device.

13. A system comprising:
one or more computers and one or more storage devices storing instructions that are operable, when executed by the one or more computers, to cause the one or more computers to perform operations comprising:
receiving, by one or more processors and from a plurality of client devices, a first request over a network for an application;
in response to receiving each first request, generating, by the one or more processors, application data that includes one or more software development kits (SDKs) incorporated in the application;
generating, by the one or more processors, tracking data that comprises (i) data identifying the one or more SDKs incorporated in the application and (ii) data identifying the client device that transmitted the first request for corresponding application data;
providing, by the one or more processors, the generated application data over the network to each client device that transmitted the first request, the one or more SDKs incorporated in the application enabling the application of each client device to communicate with a different application of a different or similar client device, wherein the one or more SDKs are incorporated in the application responsive to receipt of the first request;
identifying, by the one or more processors, a list of applications on the plurality of client devices that have the one or more SDKs based on the generated tracking data;
generating, by the one or more processors, a message to provide to each application on the list of applications; and
providing, by the one or more processors, the generated message to each application that includes the one or more SDKs, wherein the message includes a notification to be displayed on each client device through each application.

14. The system of claim 13, wherein generating the application data that includes the one or more SDKs further comprises generating, by the one or more processors, identifying, by the one or more processors, the one or more SDKs based on an operating system of the client device which transmitted the first request.

15. The system of claim 13, further comprising:
receiving, by the one or more processors, a second request from a first application of a first client device to communicate with a second application of a second client device, wherein the first application includes the one or more SDKs;
determining, by the one or more processors, whether the second application of the second client device includes the one or more SDKs; and
in response to determining that the second application of the second client device includes at least the one or more SDKs, providing, by the one or more processors, an indication to the first application that enables the first application to communicate with the second application.

16. The system of claim 13, further comprising:
receiving, by the one or more processors, a second request from a first application of a first client device to communicate with a second application of a second client device, wherein the first application includes the one or more SDKs;
determining, by the one or more processors, whether the second application of the second client device includes the one or more SDKs; and
in response to determining that the second application of the second client device does not include the one or more SDKs, providing, by the one or more processors, an indication to the first application that precludes the first application from communicating with the second application.

17. The system of claim 13, further comprising:
receiving, by the one or more processors, a third request from a first application of a first client device to communicate with a second application of the first client device, wherein the first application includes the one or more SDKs;
determining, by the one or more processors, whether the second application of the first client device includes the one or more SDKs; and
in response to determining that the second application of the first client device includes at least the one or more SDKs, providing, by the one or more processors, an indication to the first application that enables the first application on the first client device communicate with the second application on the second client device.

18. The system of claim 13, wherein the tracking data comprises a user identifier, a client device identifier, an application identifier, and the one or more SDKs for the application of the respective client device.

19. The system of claim 13, wherein providing the generated message to each application that includes the one or more SDKs further comprises providing, by the one or more processors, the message to each of the one or more SDKs of each application on each client device, wherein the message comprises at least one of a text message, a hyperlink, and an image.

20. A non-transitory computer-readable medium storing software comprising instructions executable by one or more computers which, upon such execution, cause the one or more computers to perform operations comprising:
receiving, by one or more processors and from a plurality of client devices, a first request over a network for an application;
in response to receiving each first request, generating, by the one or more processors, application data that includes one or more software development kits (SDKs) incorporated in the application;
generating, by the one or more processors, tracking data that comprises (i) data identifying the one or more SDKs incorporated in the application and (ii) data identifying the client device that transmitted the first request for corresponding application data;
providing, by the one or more processors, the generated application data over the network to each client device that transmitted the first request, the one or more SDKs incorporated in the application enabling the application of each client device to communicate with a different application of a different or similar client device, wherein the one or more SDKs are incorporated in the application responsive to receipt of the first request;
identifying, by the one or more processors, a list of applications on the plurality of client devices that have the one or more SDKs based on the generated tracking data;
generating, by the one or more processors, a message to provide to each application on the list of applications; and
providing, by the one or more processors, the generated message to each application that includes the one or more SDKs, wherein the message includes a notification to be displayed on each client device through each application.
